(19) United States
(12) Patent Application Publication
(10) Pub. No.: US 2018/0233772 A1
(43) Pub. Date: Aug. 16, 2018

(54) LITHIUM ION SECONDARY BATTERY, AND METHOD FOR PRODUCING THE SAME AND METHOD FOR EVALUATING THE SAME

(71) Applicant: NEC ENERGY DEVICES, LTD., Sagamihara-shi, Kanagawa (JP)

(72) Inventors: Hideaki SASAKI, Kanagawa (JP); Shinako KANEKO, Kanagawa (JP); Kenji WATANABE, Kanagawa (JP)

(73) Assignee: NEC ENERGY DEVICES, LTD., Sagamihara-shi, Kanagawa (JP)

(21) Appl. No.: 15/751,228

(22) PCT Filed: Sep. 14, 2016
(86) PCT No.: PCT/JP2016/077040

§ 371 Date: Feb. 8, 2018

(30) Foreign Application Priority Data
Sep. 28, 2015 (JP) 2015-189521

(51) Int. Cl. H01M 10/0525; H01M 10/0567; H01M 10/0569; H01M 10/058; H01M 10/48; H01M 4/525; H01M 4/66

(52) U.S. Cl. CPC H01M 10/0525; H01M 10/0567; H01M 10/0569; H01M 2004/028; H01M 10/48; H01M 4/525; H01M 4/662; H01M 10/058

(57) ABSTRACT

There is provided a lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution, wherein the Warburg coefficient per charge capacity (σ₀), determined by an alternating current impedance method, is 0.005 or lower.

### CROSS REFERENCE TO RELATED APPLICATIONS

This application is a National Stage of International Application No. PCT/JP2016/077040 filed Sep. 14, 2016, claiming priority based on Japanese Patent Application No. 2015-189521 filed Sep. 28, 2015, the contents of all of which are incorporated herein by reference in their entirety.

### TECHNICAL FIELD

The present invention relates to a lithium ion secondary battery, and a method for producing the same and a method for evaluating the same.

### BACKGROUND ART

Lithium ion secondary batteries, since being high in the energy density and excellent in the charge and discharge cycle characteristics, are broadly used as power sources for small-size mobile devices such as cell phones and laptop computers. Further in recent years, in consideration of environmental problems and in growing concern for energy saving, there have been raised demands for large-size power sources required to have a high capacity and a long life, including vehicular power storage batteries for cars such as electric cars and hybrid electric cars, and power storage systems such as household power storage systems.

Various studies are under way in order to improve characteristics of lithium ion secondary batteries.

For example, Patent Literature 1 describes a lithium secondary battery characterized in that: its positive electrode contains a lithium nickel composite oxide having a layered rock salt structure; a monomer (a thiophene derivative or a pyrrole derivative having an alkyl group having 1 to 10 carbon atoms, such as 3-hexylthiophene) having an alkyl group and being electrochemically polymerizable in the battery operating voltage is added to the nonaqueous electrolyte solution; and the capacity of the electric double layer determined by an alternating current impedance method is 3 F/Ah (4 mF/cm² per positive electrode area) or higher per battery discharge capacity. Then, it is stated that the secondary battery is improved in input and output characteristics in short times in a low-temperature environment.

Patent Literature 2 describes a lithium secondary battery characterized in that: its positive electrode contains a lithium nickel composite oxide having a layered rock salt structure, and an active carbon; and the electric double layer capacity determined by an alternating current impedance method is 3 F/Ah (4 mF/cm² per positive electrode area) or higher per battery discharge capacity. Then, it is stated that the secondary battery is improved in input and output characteristics in short times in a low-temperature environment.

Patent Literature 3 describes a lithium ion secondary battery characterized in that: LiBOB (lithium bis(oxalate)borate) is added to its electrolyte solution; its negative electrode contains a natural graphite coated with an amorphous carbon; a film originated from the LiBOB is formed on the surface of the coated natural graphite; and the ratio (X/Y) of an amount X (mol/l) of the LiBOB added to the electrolyte solution to a capacitance Y (F) of the negative electrode is 0.01 or higher and 0.1 or lower. Then, it is stated that the secondary battery can suppress heat generation when charge and discharge are repeated in a high-temperature environment.

Patent Literature 4 describes a method for measuring a lithium ion battery characterized in that: the measurement of the internal impedance by an alternating current impedance method and the calculation of the frequency characteristic of the impedance based on an impedance model are conducted; optimum values of parameters of each element constituting the impedance model are determined so that the measurement result and the calculation result agree with each other; and an element parameter representing ease of the charge transfer on the positive electrode surface and an element parameter representing ease of the charge transfer on the negative electrode surface are determined., and their magnitudes are compared. It is also stated that the impedance model has a first equivalent circuit representing an electrochemical impedance of its positive electrode, and a second equivalent circuit connected in series to the first equivalent circuit and representing an electrochemical impedance of its negative electrode. Then, it is stated that according to this measurement method, characteristics of the lithium ion battery can be evaluated, including the charge and discharge characteristics, the long-term reliability, and the safety.

Patent Literature 5 describes a method for evaluating an active material in which method a specific cell for evaluation is fabricated and in the case where the basic capacitance of the active material obtained by an alternating current impedance measurement of the cell is in the range of 0.1 to 0.16 F/g, the active material is evaluated as being a good-quality substance. Then, it is stated that by using the active material, such as a graphite material, evaluated as a good-quality substance, a lithium secondary battery excellent in characteristics including the reaction resistance and the capacity retention rate can be obtained.

### CITATION LIST

### Patent Literature

Patent Literature 1: JP2002-184458A

Patent Literature 2: JP2002-260634A

Patent Literature 3: JP2014-056667A

Patent Literature 4: JP2009-97878A

Patent Literature 5: JP2013-247035A

### SUMMARY OF INVENTION

### Technical Problem

Although various studies have been carried out in order to improve characteristics of lithium ion secondary batteries, further improvement of the cycle characteristics is demanded. An object of the present invention is to provide a lithium ion secondary battery excellent in cycle characteristics.

### Solution to Problem

According to an aspect of the present invention:

there is provided a lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,

wherein the Warburg coefficient per charge capacity (a₀), determined by an alternating current impedance method, is 0.005 or lower.

According to another aspect of the present invention:

there is provided a lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,

wherein the electric double layer capacity (C_{dl}) and the Warburg coefficient per charge capacity (a₀), determined by an alternating current impedance method, satisfy the following expression (1):

1/(σ₀C_{dl})≥125 (1).

According to another aspect of the present invention:

there is provided a method for evaluating a lithium ion secondary battery, the lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,

the method comprising judging and selecting the lithium ion secondary battery as being a good-quality battery when the lithium ion secondary battery has a Warburg coefficient per charge capacity (σ₀) determined by an alternating current impedance method of 0.005 or lower.

According to another aspect of the present invention:

there is provided a method for evaluating a lithium ion secondary battery, the lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,

the method comprising judging and selecting the lithium ion secondary battery as being a good-quality battery when the lithium ion secondary battery has an electric double layer capacity (C_{dl}) and a Warburg coefficient per charge capacity (σ₀), determined by an alternating current impedance method, satisfying the following expression (1):

1/(σ₀C_{dl})≥125 (1).

According to another aspect of the present invention:

there is provided a method for producing a lithium ion secondary battery, the lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,

the method comprising:

holding (A) a charged lithium ion secondary battery at 30° C. or higher and 60° C. or lower for 24 hours or longer and 720 hours or shorter;

determining a Warburg coefficient of the lithium ion secondary battery obtained after said holding (A) by an alternating current impedance method; and

judging the quality of the battery by utilizing the Warburg coefficient and selecting a good-quality battery.

### Advantageous Effect of Invention

According to the exemplary embodiment, a lithium ion secondary battery excellent in the cycle characteristics can be provided.

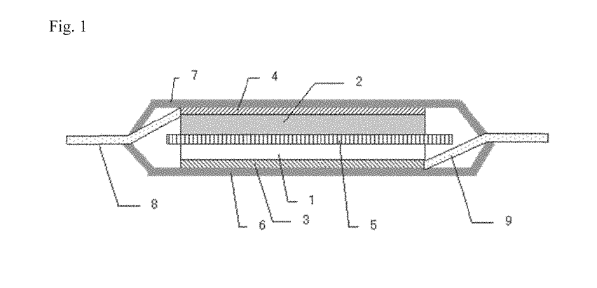

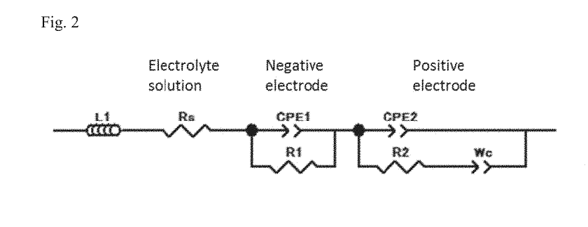

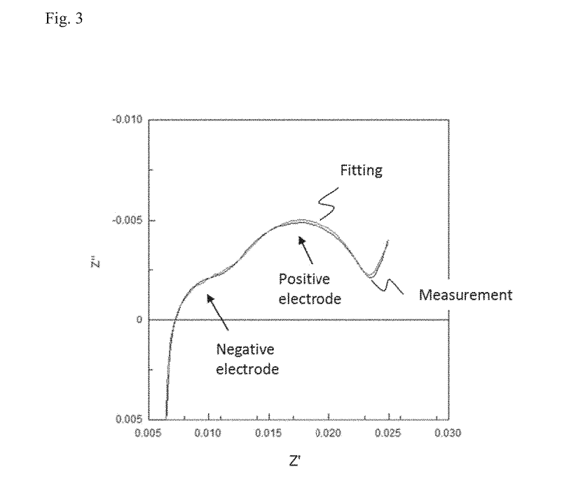

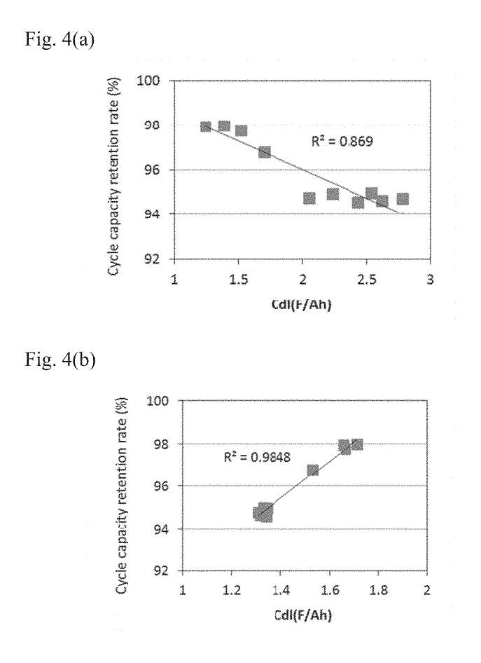

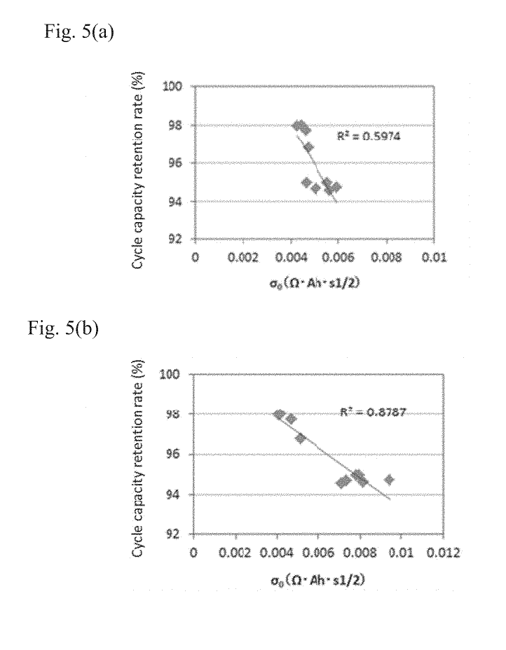

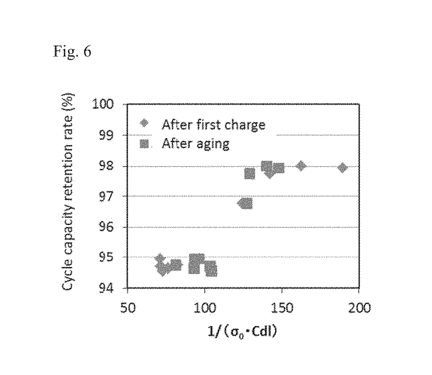

### BRIEF DESCRIPTION OF DRAWINGS

[FIG. 1] FIG. 1 is a cross-sectional view to interpret one example of a lithium ion secondary battery according to the exemplary embodiment.

[FIG. 2] FIG. 2 is an equivalent circuit diagram to interpret an electrochemical electrode model.

[FIG. 3] FIG. 3 is a diagram showing frequency characteristics of the impedance of the equivalent circuit shown in FIG. 2, on a complex plane.

[FIGS. 4(a) and 4(b)] FIGS. 4(a) and 4(b) are diagrams showing a correlation between the electric double layer capacity (C_{dl}) and the cycle capacity retention rate (FIG. 4(a) is a case before aging, and FIG. 4(b) is a case after aging).

[FIGS. 5(a) and 5(b)] FIGS. 5(a) and 5(b) are diagrams showing a correlation between the Warburg coefficient per charge capacity (σ₀) and the cycle capacity retention rate (FIG. 5(a) is a case before aging, and FIG. 5(b) is a case after aging).

[FIG. 6] FIG. 6 is a diagram showing a relation between the parameter (1/(σ₀C_{dl})) derived from the Warburg coefficient per charge capacity (σ₀) and the electric double layer capacity (C_{dl}), and the cycle capacity retention rate.

### DESCRIPTION OF EMBODIMENT

A lithium ion secondary battery according to the exemplary embodiment is a battery comprising: a positive electrode comprising, as a positive electrode active material, a lithium nickel-containing composite oxide having a layered crystal structure; a negative electrode comprising, as a negative electrode active material, a graphitic material; and an electrolyte solution, and has a constitution satisfying at least one of the following first and second conditions using parameters found by an alternating current impedance analysis. Making a lithium ion secondary battery have such a constitution enables providing the lithium ion secondary battery excellent in the cycle characteristics.

First condition:

The Warburg coefficient per charge capacity (σ₀) determined by an alternating current impedance method is 0.005 or lower.

Second condition:

The electric double layer capacity (C_{dl}) and the Warburg coefficient per charge capacity (σ₀), determined by an alternating current impedance method, satisfy the following expression (1):

1/(σ₀C_{dl})≥125 (1).

In the second condition, further it is preferable that the electric double layer capacity per charge capacity be 1.5 (F/Ah) or higher.

Here, the charge capacity of a lithium ion secondary battery means an electric capacity (Ah) in the first charge time in the battery operating voltage. Specifically, adopted is a charge capacity when constant-current constant-voltage charge is carried out at a current value corresponding to 0.2C to a battery voltage upper limit determined suitably to the constitution of the battery, such as an electrode active material, in a total time of 7 hours at an environmental temperature of 25° C.

Then, an efficient evaluation method can be provided by using at least one of the above first and second conditions as the criterion for good-quality secondary batteries, since the quality of secondary batteries can be judged and a good-quality battery can be selected without carrying out a charge and discharge cycle test of the secondary batteries.

Further in the production method of the lithium ion secondary battery, the good-quality rate can efficiently be improved and lithium ion secondary batteries excellent in the cycle characteristics can be produced efficiently at a high good-quality rate by, after the step of holding a charged state in a predetermined condition, determining the Warburg coefficient of batteries by an alternating current impedance method, and judging the quality of the produced batteries by utilizing the Warburg coefficient, and selecting good-quality batteries.

The lithium ion secondary battery according to the exemplary embodiment can include the following suitable constitution.

The electrolyte solution preferably contains a cyclic sulfonate ester compound as an additive. Further the electrolyte solution preferably comprises a carbonate solvent as a solvent. The positive electrode active material comprises a lithium nickel-containing composite oxide, and the lithium nickel-containing composite oxide has a nickel content (ratio in the number of atoms) in the metals occupying nickel sites of preferably 60% or higher. The negative electrode active material comprises a graphitic material, and the graphitic material suitably usable is a graphite such as a natural graphite or an artificial graphite, or a graphite coated with an amorphous carbon. From the viewpoint of making the cost low, preferable are a natural graphite and a natural graphite coated with an amorphous carbon.

A cross-sectional view of one example (laminate-type) of the lithium ion secondary battery according to the exemplary embodiment is shown in FIG. 1. As shown in FIG. 1, the lithium ion secondary battery of the present example has a positive electrode comprising a positive electrode current collector 3 composed of a metal such as an aluminum foil and a positive electrode active material layer 1 containing a positive electrode active material provided thereon, and a negative electrode comprising a negative electrode current collector 4 composed of a metal such as a copper foil and a negative electrode active material layer 2 containing a negative electrode active material provided thereon. The positive electrode and the negative electrode are laminated through a separator 5 composed of a nonwoven fabric, a polypropylene macroporous membrane or the like so that the positive electrode active material layer 1 and the negative electrode active material layer 2 face each other. The pair of electrodes is accommodated in a container formed of outer packages 6, 7 composed of an aluminum laminate film. A positive electrode tab 9 is connected to the positive electrode current collector 3, and a negative electrode tab 8 is connected to the negative electrode current collector 4. These tabs are led outside the container. The electrolyte solution is injected in the container, which is then sealed. There may be made a structure in which an electrode group in which a plurality of electrode pairs are laminated is accommodated in the container.

Then, the alternating current impedance analysis and the first and second conditions will be described.

In FIG. 2, an equivalent circuit used for the alternating current impedance analysis is shown. L1 in the Figure denotes an inductor; Rs, a solution resistance of an electrolyte solution; R1, a charge transfer resistance (charge transfer resistance involved in the transfer of charges between an active material and the electrolyte solution) of a negative electrode; R2, a charge transfer resistance of a positive electrode; Wc, a diffusion resistance (Warburg impedance) of lithium ions; CPE1, an electric double layer capacity (electric double layer capacity at the interface between the active material and the electrolyte solution) of the negative electrode; and CPE2, an electric double layer capacity of the positive electrode.

The alternating current impedance analysis uses an impedance measurement system composed of a potentiostat and a frequency response analyzer, and analyzes the response current by imparting a voltage micro-amplitude to a lithium secondary battery to become a measurement object. The measurement can be carried out under the conditions: an applied voltage of a voltage amplitude of 10 mV and a frequency range of 10 kHz to 50 mHz at an environmental temperature of 25′C. Here, it is preferable that the lowest frequency be established so that in a Cole-Cole plot of the measured impedance indicated on a complex plane, a Warburg impedance corresponding to a straight line part having a gradient of about 45° can be observed.

The electric double layer capacity and the diffusion resistance can be expressed by CPE (constant phase element) represented by the following expression (2).

### [Expression 1]

CPE=1/[T(l*w)^{p}] (2)

In the expression, parameters are a coefficient T and a phase p; and I* represents an imaginary unit and ω represents an angular frequency. When p=1, CPE represents an electric double layer capacity; and when p=0.5, CPE represents a diffusion resistance (Warburg impedance).

In the equivalent circuit of FIG. 2, in order to differentiate each parameter value of CPE1, CPE2 and Wc, hereinafter, the values of T and p of CPE1 are represented as CPE1-T and CPE1-P; the values of T and p of CPE2, as CPE2-T and CPE2-P; and the values of T and p of Wc, as Wc-T and Wc-P.

The diffusion resistance (Warburg impedance) Zw can be represented by the following expression (3).

### [Expression 2]

Zw=σ(1−j)/√ω (3)

In the expression, σ represents a Warburg coefficient; j represents an imaginary unit; and ω represents an angular frequency.

The Warburg coefficient σ can be represented by the following expression (4).

$$\begin{matrix}[ Expression 3 ] & \\ \begin{matrix}σ = {RT}_{a} / √ 2 {n}^{2} {F}^{2} Ar ( 1 / {D}^{1 / 2} {C}^{*} ) \\ = RTa / ( √ 2 {n}^{2} {F}^{2} {ArD}^{1 / 2} {C}^{*} )\end{matrix} & ( 4 )\end{matrix}$$

In the expression, R represents a gas constant (8.3145 J·K⁻¹·mol⁻¹); Ta, an absolute temperature (K); n, the number of electrons; F, Faraday constant (9.6845×10⁴ C·mol⁻¹); Ar, an electrode surface area (m²); D, a diffusion coefficient (m²/sec); and C*, an ion concentration (mol/m³).

In the case where p=0.5, since the expression (2) conforms to the Warburg impedance, the relation between T (=Wc-T) and σ, and the diffusion coefficient D is represented by the expression (5).

Therefore, by determining the values of Wc-T and σ from the impedance analysis of the equivalent circuit, the diffusion coefficient of ions, that is, the information on the diffusibility of lithium ions in a battery, can be obtained. The diffusibility of lithium ions is known to largely affect the battery performance, and is considered to become an important index for enhancing the battery performance.

### [Expression 4]

T=1/(√2σ)∝√D (5)

FIG. 3 shows a diagram (Cole-Cole plot) showing frequency characteristics of the impedance of the equivalent circuit shown in FIG. 2, on a complex plane. The abscissa is the real number axis and the ordinate is the imaginary number axis.

In a Cole-Cole plot, as the angular frequency co of an alternating voltage is scanned from the high-frequency side to the low-frequency side, a locus of impedances drawing a semicircle clockwise (charge transfer process) is obtained. As the frequency is further lowered, a locus of impedances increasing in the direction of 45′ to the abscissa and the ordinate (substance transfer process) is obtained. By obtaining a Cole-Cole plot, there can be calculated the charge transfer resistance, the diffusion resistance, the electric double layer capacity and the solution resistance. Here, as shown in FIG. 3, loci of superposed semicircles by the negative electrode and by the positive electrode are obtained. It is generally conceived that out of two semicircles, a semicircle on the high-frequency side is originated from a negative electrode and a semicircle on the low-frequency side is originated from a positive electrode. In the exemplary embodiment, the semicircle on the low-frequency side conceived to be originated from the positive electrode will be paid attention to.

In the exemplary embodiment, the parameter of the each element constituting the equivalent circuit model is determined by fitting, and the correlation between the obtained each parameter and the cycle characteristics was examined.

In the fitting, optimum values of the parameters of the each element constituting the equivalent circuit model are determined so that measurement data of frequency characteristics of the internal impedances of a battery conform to frequency characteristics of impedances calculated through the equivalent circuit model. The determination of the optimum values of the each parameter can be carried out by inputting initial values of the equivalent circuit model and the each parameter to a simulator, and repeatedly calculating with adjusting the each parameter so that a Cole-Cole plot obtained by the calculation coincides with the measurement data. As the simulator, there can be used a commercially available usual alternating current impedance measurement and analysis software.

A plural kind of laminate-type cells were fabricated, which contained a positive electrode containing, as a positive electrode active material, a lithium nickel-containing composite oxide having a layered crystal structure, a negative electrode containing, as a negative electrode active material, a graphitic material, and an electrolyte solution different for the each kind; and these were subjected to an alternating current impedance measurement and a charge and discharge cycle test.

With respect to the electrolyte solutions, an electrolyte solution in which a lithium salt was dissolved in a carbonate solvent, and electrolyte solutions having an additive further added thereto (a plural kind of electrolyte solutions having different kinds and concentrations of additives) were prepared. By using these electrolyte solutions, cells having the same constitution except for using different electrolyte solutions were fabricated.

The alternating current impedance measurement was carried out before and after aging was carried out. The aging can be carried out by storing a cell in a charged state at a predetermined temperature for a certain period. For example, the aging temperature may be set at room temperature or higher, but in a lithium ion secondary battery in the exemplary embodiment, is preferably 30° C. or higher and 60° C. or lower; and the aging time is preferably 24 hours or longer and 720 hours (30 days) or shorter. The aging can be carried out for purposes, such as to select cells defective due to self-discharge based on a voltage decrease after the aging, and to stabilize the SEI film of the negative electrode and thereby improve the cell characteristics by storing cells for a certain period. In the exemplary embodiment, the aging was carried out by storing cells in the fully charged state (4.15 V) at 45° C. for 14 days.

The charge and discharge cycle test determined the capacity retention rate when charge and discharge at 25° C. in 25 cycles was carried out.

The result revealed that irrespective of the analyses after the first charge (before the aging) and after the aging, the electric double layer capacity (CPE2-T) and the diffusion resistance (Warburg impedance, Wc-T) of the positive electrode have high correlations with the cycle capacity retention rate. From this, it can be presumed that the reaction surface area of the positive electrode and the diffusibility of lithium ions largely affect the cycle characteristics. Here, since CPE2-T largely varies in the magnitude depending on the cell capacity, CPE2-T per charge capacity is represented as C_{dl}, and Wc-T is represented in terms of Warburg coefficient per charge capacity (σ₀).

FIGS. 4(a) and 4(b) show a correlation between the electric double layer capacity per charge capacity (C_{dl}) and the cycle capacity retention rate (FIG. 4(a) is a case before the aging, and FIG. 4(b) is a case after the aging).

C_{dl}, when ϵ represents a permittivity; S, a surface area; and δ, an interionic distance, is represented as C_{dl}=ϵS/δ. Here, since the surface area S is represented as a product of a specific surface area S₀ (m²/g) of a material and a weight W (g) of an active material, C_{dl} can be represented as C_{dl}=ϵS₀W/δ. The weight W of an active material is, from a specific capacity C₀ (Ah/g) of the active material and a cell capacity Cs (Ah), represented as W=Cs/C₀, and it makes C_{dl}=ϵS₀Cs/C₀δ. Therefore, when the capacity of a cell is different, the value of C_{dl} differs, so the electric double layer capacity per capacity (C_{dl}/Cs) needs to be compared by using C_{dl}/Cs=ϵS₀/C₀δ. Here, since C₀ is invariable when the positive electrode material is identical, and ϵ and δ conceivably exhibit only a little variation when no large variation is made in the electrolyte solution composition, the electric double layer capacity per capacity (C_{dl}/Cs) conceivably reflects the variation in the reaction specific surface area of the active material.

As shown in FIG. 4(a), in the case before the aging, a smaller reaction surface area of the positive electrode exhibits a higher cycle retention rate. This is conceivably because favorable films are formed on active surfaces of the positive electrode active material and freshly generated surfaces due to cracking of the positive electrode active material generated during the charge time. As shown in FIG. 4(b), in the case where the aging has been carried out, a larger reaction surface area of the positive electrode exhibits a higher cycle retention rate. This is conceivably because the decomposition of the electrolyte solution on the positive electrode in a high SOC is suppressed and the reaction region of lithium ions thereby becomes large.

From the results shown in FIG. 4(b), in order to obtain a battery excellent in the cycle characteristics, it is preferable that the electric double layer capacity per charge capacity (C_{dl}) be 1.5 (F/Ah) or higher, and 1.6 (F/Ah) or higher is more preferable.

FIGS. 5(a) and 5(b) show a correlation between the Warburg coefficient per charge capacity (σ₀) and the cycle capacity retention rate (cycle retention rate (%) of ordinate) (FIG. 5(a) is a case before the aging, and FIG. 5(b) is a case after the aging).

Here, the Warburg coefficient per charge capacity (σ₀) is defined as a product of a Warburg coefficient σ and a charge capacity. From the expression (4), the Warburg coefficient σ is inversely proportional to the electrode surface area Ar. The electrode surface area is, since being proportional to the weight of the active material, proportional to the cell capacity Cs; so σ∝1/Ar∝1/Cs; the Warburg coefficient σ is thus inversely proportional to the cell capacity.

Therefore, a product σCs of σ and a cell capacity becomes a parameter not depending on the cell capacity.

From FIGS. 5(a) and 5(b), a lower Warburg coefficient, that is, a higher diffusibility of lithium ions, gives a higher cycle retention rate. This is conceivably because the intercalation and deintercalation of lithium ions are smooth.

From the result, in order to obtain a battery excellent in the cycle characteristics, it is preferable that the Warburg coefficient per charge capacity (σ) be 0.005 or lower, and 0.0045 or lower is more preferable.

Further from these results, it has been found that 1/(σ₀C_{dl}) derived from the Warburg coefficient per charge capacity (σ₀) and the electric double layer capacity (C_{dl}), not depending on the presence/absence of aging and also not depending on the cell capacity (from the above discussion, not depending on the cell capacity is self-explanatory), has a high correlation with the cycle characteristics. Since it is conceivable that a represents the diffusibility (difficulty in diffusion) of lithium ions, and (C_{dl}) represents the reaction surface area, 1/(σ₀C_{dl}) conceivably indicates the diffusibility (ease in diffusion of lithium ions at the positive electrode interface) of Li ions per the positive electrode reaction surface area. As shown in FIG. 6, when such parameters satisfy the specific conditions, a battery excellent in the cycle characteristics can be obtained.

FIG. 6 is a diagram plotted by taking 1/(σ₀C_{dl}) on the abscissa and the cycle capacity retention rate on the ordinate. It is found that a threshold of the 1/(σ₀C_{dl}) is present at around 125.

From this result, in order to obtain a battery excellent in the cycle characteristics, it is preferable that the expression (1) be satisfied, that is, 1/(σ₀C_{dl}) (=Wc/C_{dl}) be 125 or higher; 135 or higher is more preferable; and 145 or higher is still more preferable.

Hereinafter, the lithium ion secondary battery according to the exemplary embodiment will be described further.

(Positive Electrode)

As a positive electrode active material, a lithium nickel-containing composite oxide having a layered crystal structure can be used.

In the lithium nickel-containing composite oxide, the nickel content (ratio in the number of atoms) in the metals occupying nickel sites is preferably 60% or higher.

Further the lithium nickel-containing composite oxide to be used is preferably one in which a part of nickel on the nickel sites is substituted with another metal.

The metal other than Ni occupying the nickel sites is preferably at least one metal selected from, for example, Mn, Co, Al, Mg, Fe, Cr, Ti and In.

The lithium nickel-containing composite oxide preferably comprises Co as a metal other than Ni occupying the nickel sites. Further the lithium nickel-containing composite oxide more preferably comprises, in addition to Co, Mn or Al, that is, there can suitably be used a lithium nickel cobalt manganese composite oxide having a layered crystal structure (NCM), a lithium nickel cobalt aluminum composite oxide having a layered crystal structure (NCA), or a mixture thereof.

As the lithium nickel-containing composite oxide having a layered crystal structure, one represented by the following formula can suitably be used.

Li₁₊ₐ(Ni_{b}Co_{c}Me1_{d}Me2_{1-b-c-d})O₂

wherein Me1 is Mn or Al; Me2 is at least one (excluding the same metal as Me1) selected from the group consisting of Mn, Al, Mg, Fe, Cr, Ti and In; and −0.5≤a<0.1, 0.1≤b<1, 0<c<0.5, and 0<d<0.5.

In the above formula, 0.6≤b<1, 0<c<0.4 and 0<d<0.4 are preferable, and 0.6≤b≤0.9, 0<c<0.4 and 0<d<0.4 are more preferable.

The average particle diameter of the positive electrode active material is, from the viewpoint of the reactivity with an electrolyte solution, the rate characteristics and the like, for example, preferably 0.1 to 50 μm, more preferably 1 to 30 μm, and still more preferably 2 to 25 μm. Here, the average particle diameter means a particle diameter (median diameter: D₅₀) at a cumulative value of 50% in a particle size distribution (in terms of volume) by a laser diffraction scattering method.

The positive electrode is constituted of a positive electrode current collector, and a positive electrode active material layer on the positive electrode current collector. The positive electrode is disposed so that the active material layer faces a negative electrode active material layer on a negative electrode current collector through a separator.

The positive electrode active material layer can be formed as follows. The positive electrode active material layer can be formed by first preparing a slurry containing the positive electrode active material, a binder and a solvent (as required, further a conductive auxiliary agent), applying and drying the slurry on the positive electrode current collector, and as required, pressing the dried slurry. As the slurry solvent to be used in the positive electrode fabrication, N-methyl-2-pyrrolidone (NMP) can be used.

As the binder, there can be used ones to be usually used as binders for positive electrodes, such as polytetrafluoroethylene (PTFE) and polyvinylidene fluoride (PVDF).

The positive electrode active material layer can contain, in addition to the positive electrode active material, a conductive auxiliary agent and a binder. The conductive auxiliary agent is not especially limited, and there can be used conductive materials to be usually used as conductive auxiliary agents for positive electrodes, such as carbonaceous materials such as carbon black, acetylene black, natural graphite, artificial graphite, and carbon fibers. Further as the binder, there can be used binders to be usually used for positive electrodes, such as polytetrafluoroethylene (PTFE) and polyvinylidene fluoride (PVDF).

Although a higher proportion of the positive electrode active material in the positive electrode active material layer is better because the capacity per mass becomes larger, addition of a conductive auxiliary agent is preferable from the point of reduction of the electrode resistance of the electrode; and addition of a binder is preferable from the point of the electrode strength. A too low proportion of the conductive auxiliary agent makes it difficult for a sufficient conductivity to be kept, and becomes liable to lead to an increase in the electrode resistance. A too low proportion of the binder makes it difficult for the adhesive power with the current collector, the active material and the conductive auxiliary agent to be kept, and causes electrode exfoliation in some cases. From the above points, the content of the conductive auxiliary agent in the conductive auxiliary agent is preferably 1 to 10% by mass; and the content of the binder in the active material layer is preferably 1 to 10% by mass.

The positive electrode active material layer may contain other lithium-containing compounds such as lithium carbonate and lithium hydroxide. The lithium nickel-containing composite oxide having a layered crystal structure contains residual Li components such as Li₂CO₃ and LiOH in some cases. These residual Li components assume an alkalinity and cause the decomposition of an electrolyte solution, and thereby may possibly cause the cycle deterioration and the gas generation. Hence, it is preferable to use a lithium nickel-containing composite oxide in which the content of the residual Li components is suppressed to such a degree that does not cause such deterioration and gas generation. Although it is generally conceived that additives of an electrolyte solution react with the electrolyte solution on a negative electrode and form SEI films to thereby suppress the reductive decomposition of the electrolyte solution on the negative electrode, it is conceivable that the residual Li components in a positive electrode and the additives, though depending on the additives, specifically react and the decomposition of the electrolyte solution by the residual Li components possibly may be thereby suppressed.

As the positive electrode current collector, aluminum, stainless steels, nickel, titanium and alloys thereof can be used. The shape thereof includes foils, flat plates and mesh forms. Particularly aluminum foils can suitably be used.

The porosity of the positive electrode active material layer (not including the current collector) is preferably 10 to 30%, and more preferably 20 to 25%. When the porosity of the positive electrode active material layer is made to be in the above values, it is preferable because the discharge capacity in use at a high discharge rate is improved.

The porosity means a proportion of a remainder volume obtained by subtracting a volume occupied by particles of the active material, the conductive auxiliary agent and the like from an apparent volume of the active material layer as a whole, in the apparent volume. Therefore, the porosity can be determined by calculations from the thickness and the weight per unit area of the active material layer and the true densities of particles of the active material, the conductive auxiliary agent and the like.

Porosity=(an apparent volume of the active material layer−a volume of the particles)/(an apparent volume of the active material layer)

Here, the “volume of the particles” (a volume occupied by the particles contained in the active material layer) in the above expression can be calculated by the following expression.

A volume of the particles=(a weight per unit area of the active material layer×an area of the active material layer×a content of the particles)/(a true density of the particles)

Here, the “area of the active material layer” refers to an area of a plane thereof on the opposite side (separator side) to the current collector side.

(Negative Electrode)

As the negative electrode active material, a carbonaceous material can be used. The carbonaceous material includes graphite, amorphous carbon (for example, graphitizable carbon, non-graphitizable carbon), diamond-like carbon, fullerene, carbon nanotubes and carbon nanohorns. As the graphite, natural graphite and artificial graphite can be used, and from the viewpoint of the material cost, inexpensive natural graphite is preferable. Examples of the amorphous carbon include materials obtained by heat-treating coal pitch coke, petroleum pitch coke, acetylene pitch coke and the like.

The average particle diameter of the negative electrode active material is, from the point of suppressing side-reactions during the charge and discharge time and thereby suppressing a decrease in the charge and discharge efficiency, preferably 1 μm or larger, more preferably 2 μm or larger, and further preferably 5 μm or larger, and from the viewpoint of the input and output characteristics and the viewpoint of the electrode fabrication (smoothness of the electrode surface, and the like), preferably 80 μm or smaller, and more preferably 40 μm or smaller. Here, the average particle diameter means a particle diameter (median diameter: D₅₀) at a cumulative value of 50% in a particle size distribution (in terms of volume) by a laser diffraction scattering method.

With respect to the fabrication of the negative electrode, the negative electrode (a current collector, and a negative electrode active material layer thereon) can be obtained by mixing the negative electrode active material (carbonaceous material), a binder, a solvent, and as required, a conductive auxiliary agent to prepare a slurry containing these, applying and drying the slurry on the negative electrode current collector, and as required, pressing the dried slurry to thereby form the negative electrode active material layer. An applying method of the negative electrode slurry includes a doctor blade method, a die coater method and a dip coating method. To the slurry, as required, additives such as a defoaming agent and a surfactant may be added.

The content of the binder in the negative electrode active material layer is, from the viewpoint of the binding power and the energy density, which are in a tradeoff relation, in terms of content with respect to the negative electrode active material, preferably in the range of 0.5 to 30% by mass, more preferably in the range of 0.5 to 25% by mass, and still more preferably in the range of 1 to 20% by mass. In the case of attaching importance to the energy density while securing a sufficient binding power, the content is preferably 1 to 15% by mass, and more preferably 1 to 10% by mass.

As the solvent, an organic solvent such as N-methyl-2-pyrrolidone (NMP) or water can be used. In the case of using an organic solvent as the solvent, a binder for the organic solvent, such as polyvinylidene fluoride (PVDF) can be used. In the case of using water as the solvent, a rubber binder (for example, SBR (styrene-butadiene rubber)) or an acrylic binder can be used. As such aqueous binders, emulsion-form binders can be used. In the case of using water as the solvent, it is preferable to concurrently use an aqueous hinder and a thickener such as CMC (carboxymethyl cellulose).

The acrylic binder includes polymers (homopolymers or copolymers) containing units of acrylic acid or methacrylic acid, or esters or salts thereof (hereinafter, referred to as “acryl units”). The copolymers include copolymers containing the acryl units and styrene units, and copolymers containing the acryl units and silicone units. As the acrylic binder, one prepared in an aqueous emulsion state can be used.

The thickener includes water-soluble polymeric thickeners such as cellulose derivatives, polyvinyl alcohol or modified substances thereof, starch or modified substances thereof, polyvinylpyrrolidone, polyacrylic acid or salts thereof, and polyethylene glycol. Among these, cellulose derivatives are preferable, and carboxymethyl cellulose (CMC) is more preferable. As the CMC, a sodium salt or an ammonium salt thereof can be used.

The content of the water-soluble polymeric thickener in the negative electrode active material layer is, in terms of content with respect to the negative electrode active material, preferably in the range of 0.2 to 10% by mass, more preferably in the range of 0.5 to 5% by mass, and still more preferably in the range of 0.5 to 2% by mass. The content of the thickener is, from the point of the electric resistance of the negative electrode active material layer, preferably 10% by mass or lower, and from the, point of enhancing the dispersibility and the adhesiveness of active material particles to provide a sufficient binding power, preferably 0.2% by mass or higher.

The negative electrode active material layer may contain a conductive auxiliary agent, as required. As the conductive auxiliary agent, there can be used conductive materials generally used as conductive auxiliary agents for negative electrodes, such as carbonaceous materials such as carbon black, Ketjen black and acetylene black. The content of the conductive auxiliary agent in the negative electrode active material layer is, in terms of content with respect to the negative electrode active material, preferably in the range of 0.1 to 3.0% by mass. The content of the conductive auxiliary agent with respect to the negative electrode active material is, from the viewpoint of forming a sufficient conduction path, preferably 0.1% by mass or higher, and more preferably 0.3% by mass or higher, and from the point of suppressing the gas generation due to the decomposition of an electrolyte solution and a decrease in the exfoliation strength due to the decomposition of an electrolyte solution that are caused by excessive addition of the conductive auxiliary agent, preferably 3.0% by mass or lower, and more preferably 1.0% by mass or lower.

As the negative electrode current collector, there can be used copper, stainless steel, nickel, titanium and alloys thereof. The shape thereof includes foils, flat plates and mesh forms.

(Electrolyte Solution)

As an electrolyte solution, there can be used a nonaqueous electrolyte solution in which a lithium salt is dissolved in one or two or more nonaqueous solvents.

The nonaqueous solvent includes cyclic carbonates such as ethylene carbonate (EC), propylene carbonate (PC), butylene carbonate (BC) and vinylene carbonate (VC); chain carbonates such as dimethyl carbonate (DMC), diethyl carbonate (DEC), ethyl methyl carbonate (EMC) and dipropyl carbonate (DPC); aliphatic carbonate esters such as methyl formate, methyl acetate and ethyl propionate; γ-lactones such as Γ-butyrolactone; chain ethers such as 1,2-ethoxyethane (DEE) and ethoxymethoxyethane (EME); and cyclic ethers such as tetrahydrofuran and 2-methyltetrahydrofuran. These nonaqueous solvents can be used singly or as a mixture of two or more.

The lithium salt to be dissolved in the nonaqueous solvent is not especially limited, but examples thereof include LiPF₆, LiAsF₆, LiAlCl₄, LiClO₄, LiSbF₆, LiCF₃SO₃, LiCF₃CO₂, Li(CF₃SO₂)₂, LiN(CF₃SO₂)₂, and lithium bisoxalatoborate. These lithium salts can be used singly or as a combination of two or more. Further as a nonaqueous electrolyte, a polymer component may be contained. The concentration of the lithium salt can be established in the range of 0.8 to 1.2 mol/L, and 0.9 to 1.1 mol/L is preferable.

(Additives)

It is preferable that the electrolyte solution contain compounds to be usually used as additives for nonaqueous electrolyte solutions. Examples thereof include carbonate compounds such as vinylene carbonate and fluoroethylene carbonate; acid anhydrides such as maleic anhydride; boron additives such as boronate esters; sulfite compounds such as ethylene sulfite; cyclic monosulfonate esters such as 1,3-propanesultone, 1,2-propanesultone, 1,4-butanesultone, 1,2-butanesultone, 1,3-butanesultone, 2,4-butanesultone and 1,3-pentanesultone; and cyclic disulfonate, ester compounds such as methylene methanedisulfonate (1,5,2,4-dioxadithian-2,2,4,4-tetraoxide) and ethylene methanedisulfonate. These additives may be used singly or as a mixture of two or more. Particularly from the point of being capable of effectively forming a film on the positive electrode surface and improving the battery characteristics, cyclic sulfonate ester compounds are preferable, and cyclic disulfonate compounds are preferable.

The content of the additives such as cyclic sulfonate esters in the electrolyte solution is, from the point of providing a sufficient addition effect while suppressing increases in the viscosity and resistance of the electrolyte solution, preferably 0.01 to 10% by mass, and more preferably 0.1 to 5% by mass. When the electrolyte solution contains a sufficient amount of cyclic sulfonate esters, the film can effectively be formed on the positive electrode surface and the battery characteristics can be improved.

As the cyclic sulfonate ester compounds, cyclic disulfonate compounds represented by the following formula (A) are preferable.

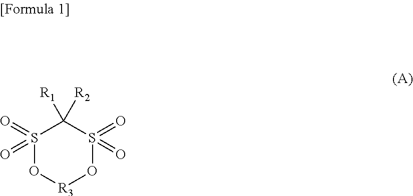

In the formula, R₁ and R₂ each independently denote an atom or a substituent selected from the group consisting of a hydrogen atom, alkyl groups having 1 to 5 carbon atoms, halogen atoms and an amino group; and R₃ denotes a linkage group selected from the group consisting of alkylene groups having 1 to 5 carbon atoms, a carbonyl group, a sulfinyl group, a sulfonyl group, fluoroalkylene groups having 1 to 6 carbon atoms and divalent groups having 2 to 6 carbon atoms in which alkylene groups or fluoroalkylene groups are bonded through an ether bond.

In the formula (A), either of R₁ and R₂ may be substituted with an atom other than a hydrogen atom, or a substituent. That is, at least one of R₁ and R₂ in the formula (A) may be an atom or a substituent selected from the group consisting of alkyl groups having 1 to 5 carbon atoms, halogen atoms and an amino group. The halogen atoms include a fluorine atom, a chlorine atom and a bromine atom.

In the formula (A), both of R₁ and R₂ may be hydrogen atoms; one thereof may be a hydrogen atom and the other may be an alkyl group having 1 to 5 carbon atoms; and both of R₁ and R₂ may be each independently an alkyl group having 1 to 5 carbon atoms, but at least one of R₁ and R₂ is more preferably a hydrogen atom.

The alkyl group of R₁ and R₂ in the formula (A) includes a methyl group, an ethyl group, propyl group, a butyl group and a pentyl group, and these groups may be linear or branched. Particularly a methyl group, an ethyl group and a propyl group are preferable.

R₃ in the formula (A) is preferably an alkylene group having 1 to 5 carbon atoms or a fluoroalkylene group having 1 to 6 carbon atoms, more preferably an alkylene group having I to 3 carbon atoms or a fluoroalkylene group having 1 to 3 carbon atoms, and still more preferably an alkylene group having 1 or 2 carbon atoms or a fluoroalkylene group having 1 or 2 carbon atoms. These alkylene groups and fluoroalkylene groups may be linear or branched. As these alkylene groups and fluoroalkylene groups, preferable are a methylene group, an ethylene group, a monofluoromethylene group, a difluoromethylene group, a monofluoroethylene group, a difluoroethylene group, a trifluoroethylene group and a tetrafluoroethylene group. Among these, a methylene group and an ethylene group are more preferable, and a methylene group is most preferable.

Preferable compounds represented by the formula (A) include a compound in which R₁ and R₂ are hydrogen atoms, and R₃ is a methylene group or an ethylene group (preferably a methylene group), and a compound in which one of R₁ and R₂ is a hydrogen atom, the other thereof is an alkyl group having 1 to 5 carbon atoms (preferably an alkyl group having 1 to 3 carbon atoms), and R₃ is a methylene group or an ethylene group (preferably a methylene group).

The compounds represented by the formula (A) may be used singly or as a mixture of two or more.

(Separator)

As the separator, there can be used resin-made porous membranes, woven fabrics, nonwoven fabrics and the like. Examples of the resin constituting the porous membrane include polyolefin resins such as polypropylene and polyethylene, polyester resins, acryl resins, styrene resins and nylon resins. Particularly polyolefin macroporous membranes are preferable because being excellent in the ion permeability, and the capability of physically separating a positive electrode and a negative electrode. Further as required, a layer containing inorganic particles may be formed on the separator, and the inorganic particles include those of insulative oxides, nitrides, sulfides, carbide and the like. Among these, it is preferable that TiO₂ or Al₂O₃ be contained.

(Outer Packaging Container)

As an outer packaging container, there can be used cases composed of flexible films, can cases and the like, and from the viewpoint of the weight reduction of batteries, flexible films are preferably used.

As the flexible film, a film having resin layers provided on front and back surfaces of a metal layer as a base material can be used. As the metal layer, there can be selected one having a barrier property including prevention of leakage of the electrolyte solution and infiltration of moisture from the outside, and aluminum, stainless steel or the like can be used. At least on one surface of the metal layer, a heat-fusible resin layer of a modified polyolefin or the like is provided. An outer packaging container is formed by making the heat-fusible resin layers of the flexible films to face each other and heat-fusing the circumference of a portion accommodating an electrode laminated body. On the surface of the outer package on the opposite side to a surface thereof on which the heat-fusible resin layer is formed, a resin layer of a nylon film, a polyester resin film or the like can be provided.

### EXAMPLES

Electrolyte solutions indicated below were used and laminate-type cells having the following same constitution except for using different electrolyte solutions were fabricated and subjected to an alternating current impedance measurement and a charge and discharge cycle test.

(Preparation of Electrolyte Solutions)

A mixed solution of EC and DEC (EC/DEC=3/7 (in volume ratio)) as a solvent of electrolyte solutions was used; and an electrolyte solution in which 1 mol/L of LiPF₆ as a lithium salt was dissolved in the mixed solvent, and electrolyte solutions in which an additive was further added to the electrolyte solution (a plurality of electrolyte solutions having different kinds and concentrations of the additive) were prepared.

As the additive to be added to the electrolyte solution, methane dimethylene disulfonate (MMDS), vinylene carbonate (VC) and fluoroethylene carbonate (FEC) were used.

The prepared electrolyte solutions were as follows.

An electrolyte solution 1: no additive

An electrolyte solution 2: a sulfur additive (MMDS), an additive concentration of 0.4% by mass

An electrolyte solution 3: a sulfur additive (MAIDS), an additive concentration of 0.8% by mass

An electrolyte solution 4: a sulfur additive (MMDS), an additive concentration of 1.2% by mass

An electrolyte solution 5: a sulfur additive (MMDS), an additive concentration of 1.6% by mass

An electrolyte solution 6: a carbonate additive (VC), an additive concentration of 0.5% by mass

An electrolyte solution 7: a carbonate additive (VC), an additive concentration of 1.0% by mass

An electrolyte solution 8: a carbonate additive (VC), an additive concentration of 1.5% by mass

An electrolyte solution 9: a fluorinated carbonate additive (FEC), an additive concentration of 0.5% by mass

An electrolyte solution 10: a fluorinated carbonate additive (FEC), an additive concentration of 1.0% by mass

(Fabrication of Batteries)

(Negative Electrodes)

A graphite (surface-coated natural graphite) was used as a negative electrode active material; water was used as a solvent; and an aqueous slurry containing the graphite, SBR and CMC was prepared (composition was graphite:SBR:CMC=97:2:1 in mass ratio). The slurry was applied on copper foils, and dried. Thereafter, the coated materials were compressed by a roll press machine to thereby fabricate negative electrode sheets having a density of the coated film (negative electrode active material layer) of 1.4 g/cm³ and a basis weight (both surfaces) of 24 mg/cm²; and the sheets were processed into a predetermined size to thereby obtain negative electrodes. The electrode area (active material-coated portion) was 12 cm×6 cm.

(Positive Electrodes)

NCM811 (LiNi_{0.8}Co_{0.1}Mn_{0.1}O₂) was used as a positive electrode active material; N-methyl-2-pyrrolidone was used as a solvent; and a slurry containing NCM811, a carbon (conductive auxiliary agent) and PVDF was prepared (composition was NCM811/carbon/PVDF=92/5/3 in mass ratio). The slurry was applied on aluminum foils, and dried. Thereafter, the coated materials were compressed by a roll press machine to thereby fabricate positive electrode sheets having a density of the coated film (positive electrode active material layer) of 3.3 g/cm³ and a basis weight (both surfaces) of 40 mg/cm²; and the sheets were processed into a predetermined size to thereby obtain positive electrodes. The electrode area (active material-coated portion) was 12 cm×6 cm.

(Cell Structure)

The negative electrodes were stacked on both sides of the positive electrode so that the positive electrode active material layer and the negative electrode active material layer face each other through a separator composed of a porous film to thereby obtain a laminated body of 5 sheets of the positive electrodes and 6 sheets of the negative electrodes. An extraction electrode for the positive electrode was installed and an extraction electrode for the negative electrode was installed; thereafter, the laminated body was wrapped with an aluminum laminate film; the electrolyte solution was injected therein; and the laminated film was sealed. The cell capacity (charge capacity) was 3 Ah.

(Measurement and Analysis of the Alternating Current Impedance)

The fabricated batteries were subjected to an alternating current impedance measurement before aging and after aging.

The alternating current impedance measurement was carried out by using a 1280Z-type electrochemical measurement system, manufactured by Solartron Analytical Co. Fitting was carried out by using equivalent circuit analysis software (trade name: Zview Version: 2.9b, manufactured by Solartron Analytical Co.). The measurement was carried out under the conditions of an environmental temperature of 25° C., and an applied voltage of an amplitude of 10 mV and a frequency range of 10 kHz to 50 mHz. Here, the lowest frequency was established so that in a Cole-Cole plot of the measured impedances on a complex plane, Warburg impedances corresponding to a straight line part having a gradient of about 45° could be observed. The equivalent circuit used was the circuit shown in FIG. 2 described before.

(Charge and Discharge Cycle Test, Capacity Retention Rate)

The capacity retention rate is a ratio (%) of a discharge capacity after the cycles to a recovery discharge capacity after aging (discharge capacity before the cycles).

A charge and discharge cycle test was carried out under the following charge and discharge conditions.

Charge: CCV charge at 1C, an upper limit voltage of 4.15 V (charge termination voltage), a charge time of 2.5 hours; Discharge: CC discharge at 1C, a lower limit voltage of 2.5 V (discharge termination voltage); The environmental temperature during the charge and discharge cycles: 25° C.; The number of cycles of charge and discharge: 25 cycles

(Aging)

Aging was carried out by storing the cell in the full charge state (4.15 V) at 45° C. for 14 days.

(Analysis Results and Cycle Capacity Retention Rates)

As results of the alternating current impedance analysis and the charge and discharge cycle test, there were obtained:

FIGS. 4(a) and 4(b) showing a correlation between the electric double layer capacity per charge capacity and the cycle capacity retention rate (FIG. 4(a) is a case before the aging, and FIG. 4(b) is a case after the aging);

FIGS. 5(a) and 5(b) showing a correlation between the Warburg coefficient per charge capacity (σ₀) and the cycle capacity retention rate (FIG. 5(a) is a case before the aging, and FIG. 5(b) is a case after the aging); and

FIG. 6 showing a relation between the parameter (1/(σ₀C_{dl})) derived from the Warburg coefficient per charge capacity (σ₀) and the electric double layer capacity (C_{dl}), and the cycle capacity retention rate.

As described before, it was found that irrespective of the analyses after the first charge (before the aging) and after the aging, the electric double layer capacity (CPE2-T) and the diffusion resistance (Warburg impedance, Wc-T) of the positive electrode had high correlations with the cycle capacity retention rate. From this, it can be presumed that the reaction surface area of the positive electrode and the diffusibility of lithium ions largely affect the cycle characteristics.

From the results shown in FIG. 4(b), it is found that in order to obtain a battery excellent in the cycle characteristics, it is preferable that the electric double layer capacity per charge capacity (C_{dl}) be 1.5 (F/Ah) or higher, and 1.6 (F/Ah) or higher is more preferable.

From the results shown in FIGS. 5(a) and 5(b), it is found that in order to obtain a battery excellent in the cycle characteristics, it is preferable that the Warburg coefficient per charge capacity (σ₀) be 0.005 or lower, and 0.0045 or lower is more preferable.

From the results shown in FIG. 6, it is found that in order to obtain a battery excellent in the cycle characteristics, it is preferable that the expression (1) be satisfied, that is, 1/(σ₀C_{dl}) be 125 or higher; 135 or higher is more preferable; and 145 or higher is still more preferable.

As found from these results, according to the production method comprising the step of determining the Warburg coefficient (σ₀) after the aging step, by utilizing the Warburg coefficient (σ₀), the quality of products can be judged by a method determining whether or not a predetermined threshold is exceeded, or the like, and batteries whose cycle characteristics may possibly decrease are enabled to be removed.

In the foregoing, the present invention has been described with reference to the exemplary embodiments and the Examples; however, the present invention is not limited to the exemplary embodiments and the Examples. Various modifications understandable to those skilled in the art may be made to the constitution and details of the present invention within the scope thereof.

### REFERENCE SIGNS LIST

1 POSITIVE ELECTRODE ACTIVE MATERIAL LAYER

2 NEGATIVE ELECTRODE ACTIVE MATERIAL LAYER

3 POSITIVE ELECTRODE CURRENT COLLECTOR

4 NEGATIVE ELECTRODE CURRENT COLLECTOR

5 SEPARATOR

6 LAMINATE OUTER PACKAGE

7 LAMINATE OUTER PACKAGE

8 NEGATIVE ELECTRODE TAB

9 POSITIVE ELECTRODE TAB

1. A lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,
wherein a Warburg coefficient per charge capacity (σ₀), determined by an alternating current impedance method, is 0.005 or lower.

2. A lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,
wherein an electric double layer capacity (C_{dl}) and a Warburg coefficient per charge capacity (σ₀), determined by an alternating current impedance method, satisfy the following expression (1):
1/(σ₀C_{dl})≥125 (1).

3. The lithium ion secondary battery according to claim 2, wherein the Warburg coefficient per charge capacity (σ₀) is 0.005 or lower.

4. The lithium ion secondary battery according to claim 2, wherein the electric double layer capacity per charge capacity is 1.5 (F/Ah) or higher.

5. The lithium ion secondary battery according to claim 1, wherein the electrolyte solution comprises a cyclic sulfonate ester compound.

6. The lithium ion secondary battery according to claim 5, wherein the electrolyte solution comprises, as the cyclic sulfonate ester compound, a cyclic disulfonate ester compound represented by the following formula (A): 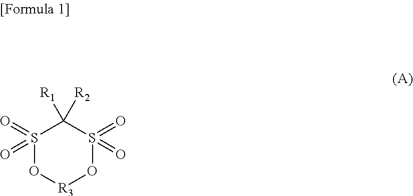
wherein R₁ and R₂ each independently denote an atom or a substituent selected from the group consisting of a hydrogen atom, alkyl groups having 1 to 5 carbon atoms, halogen atoms and an amino group; and R₃ denotes a linkage group selected from the group consisting of alkylene groups having 1 to 5 carbon atoms, a carbonyl group, a sulfinyl group, a sulfonyl group, fluoroalkylene groups having 1 to 6 carbon atoms and divalent groups having 2 to 6 carbon atoms in which alkylene groups or fluoroalkylene groups are bonded through an ether bond.

7. The lithium ion secondary battery according to claim 1, wherein the lithium nickel-containing composite oxide has a nickel content (ratio in the number of atoms) in the metals occupying nickel sites of 60% or higher.

8. The lithium ion secondary battery according to claim 1, wherein the lithium nickel-containing composite oxide comprises, as metals other than nickel occupying the nickel sites, cobalt and manganese, or cobalt and aluminum.

9. The lithium ion secondary battery according to claim 1, wherein the electrolyte solution comprises a carbonate solvent.

10. A method for evaluating a lithium ion secondary battery, the lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,
the method comprising judging and selecting the lithium ion secondary battery as being a good-quality battery when the lithium ion secondary battery has a Warburg coefficient per charge capacity (σ₀) determined by an alternating current impedance method of 0.005 or lower.

11. A method for evaluating a lithium ion secondary battery, the lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,
the method comprising judging and selecting the lithium ion secondary battery as being a good-quality battery when the lithium ion secondary battery has an electric double layer capacity (C_{dl}) and a Warburg coefficient per charge capacity (σ₀), determined by an alternating current impedance method, satisfying the following expression (1):
1/(σ₀C_{dl})≥125 (1).

12. A method for producing a lithium ion secondary battery, the lithium ion secondary battery comprising: a positive electrode comprising, as a positive electrode active material, a lithium nickel-containing composite oxide having a layered crystal structure; a negative electrode comprising, as a negative electrode active material, a graphitic material; and an electrolyte solution,
the method comprising:
holding (A) a charged lithium ion secondary battery at 30° C. or higher and 60° C. or lower for 24 hours or longer and 720 hours or shorter;
determining a Warburg coefficient of the lithium ion secondary battery obtained after said holding (A) by an alternating current impedance method; and
judging the quality of the battery by utilizing the Warburg coefficient and selecting a good-quality battery.
